(19) United States
(12) Patent Application Publication
(10) Pub. No.: US 2011/0274989 A1
(43) Pub. Date: Nov. 10, 2011

(54) CATALYSTS FOR OXYGEN REDUCTION AND EVOLUTION IN METAL-AIR ELECTROCHEMICAL CELLS

(75) Inventors: Yi-Chun Lu, Danshuei Township (TW); Hubert A. Gasteiger, Cambridge, MA (US); Yang Shao-Horn, Cambridge, MA (US)

(73) Assignee: MASSACHUSETTS INSTITUTE OF TECHNOLOGY, Cambridge, MA (US)

(21) Appl. No.: 13/098,653

(22) Filed: May 2, 2011

Related U.S. Application Data
(60) Provisional application No. 61/330,264, filed on Apr. 30, 2010.
(60) Provisional application No. 61/353,190, filed on Jun. 9, 2010.
(60) Provisional application No. 61/397,453, filed on Jun. 10, 2010.

(51) Int. Cl. H01M 12/06; H02J 7/00; B01J 23/66; B82Y 99/00

(52) U.S. Cl. 429/405; 502/330; 320/137; 977/948

(57) ABSTRACT

Methods and devices for catalyzing reactions, e.g., in a metal-air electrochemical cell, are disclosed. In some instances, a porous positive electrode of the metal-air electrochemical cell includes a metal to catalyze a reaction at the electrode (e.g., oxidation of one or more metal-oxide species). The metal can be disposed as nanoparticles, and/or be combined with a second metal. Other aspects are directed to devices and methods that can generally promote a chemical reaction (e.g., an oxidation/reduction reaction) such as the formation of platinum containing nanoparticles that can be used to catalyze electrochemical reactions.

### CROSS-REFERENCE TO RELATED APPLICATIONS

The present application claims priority to U.S. Provisional Application No. 61/330,264, filed on Apr. 30, 2010 and entitled “Catalysts for Oxygen Reduction and Evolution in Metal-Air Electrochemical Cells;” U.S. Provisional Application No. 61/353,190, filed on Jun. 9, 2010 and entitled “Catalysts for Promoting Chemical Reactions;” and U.S. Provisional Application No. 61/397,453, filed on Jun. 10, 2010 and entitled “Catalysts for Promoting Chemical Reactions;” all of which are hereby incorporated by reference in their entirety.

### STATEMENT REGARDING FEDERALLY SPONSORED RESEARCH OR DEVELOPMENT

This invention was made with Government support under Grant No. DE-AC02-05CH11231, awarded by the Department of Energy. The Government has certain rights in this invention.

### FIELD OF THE APPLICATION

The present application relates generally to chemical catalysis, electrochemical technology, and in particular to catalysts for electrochemical reactions, fuel cells and/or batteries.

### BACKGROUND OF THE APPLICATION

Demand continues to grow for lighter and longer lasting power sources for consumer electronic devices, such as laptop computers, cell phones and other hand held instruments. Likewise, hybrid-electric and all-electric vehicles increasingly need rechargeable batteries with higher energy and capacities to increase the range of such vehicles for a fixed battery mass or volume. One of the most promising technologies to meet these needs lies in metal-air electrochemical cells. In metal-air batteries, a metal containing compound such as lithium metal, lithiated carbon, or lithiated silicon forms the negative electrode. Positively-charged metal cations from the negative electrode migrate through an electrolyte to an oxygen/air permeable porous positive electrode to form oxygen-containing compounds such as oxides, hydroxides, or carbonates during discharge. The cation migration in the electrochemical cell is associated with flow of electrons through an external load from the negative electrode to the positive electrode, which generates electrical work.

Metal-air batteries have much higher energy densities than conventional lithium ion batteries. In particular, lithium-air batteries can potentially reach over three-fold greater gravimetric energy density than lithium-ion batteries in a fully-packed cell level. Four different types of lithium-air batteries have been explored depending on the types of electrolytes used. The three liquid electrolyte systems are non-aqueous, aqueous, and a mixed non-aqueous-aqueous. The fourth system is an all-solid-state system. During discharge of a non-aqueous lithium-air battery for example, oxygen is reduced by lithium ions to form lithium (per)oxides via:

2Li⁺+2e⁻+O₂ [symbol] (Li₂O₂)_{solid} Eᵣₑᵥ=2.96 V_{Li}

4Li⁺+4e⁻+O₂ [symbol] 2(Li₂O)_{solid} Eᵣₑᵥ=2.91 V_{Li}.

where V_{Li} is the standard Li/Li⁺ electropotential value. As well, the use of an air-based positive electrode can lower battery weight, and potentially boost the gravimetric energy density (battery energy output normalized to battery mass) of batteries, which is of particular importance in a number of applications such as increasing electric vehicle distance range between charging events.

Li-air batteries face substantial challenges that currently limit their practical applications, including sluggish oxygen reduction reaction (ORR) during discharge and oxygen evolution reaction (OER) kinetics during charging in Lⁱ⁺-containing aprotic electrolyte. For instance, the reaction kinetics at the air electrode are typically poor, showing round trip efficiencies between the discharge and charge potentials of below 70%, while exhibiting low rate capability (e.g., about 0.1 mA/cm²).

Accordingly, a need exits to provide techniques and methods that can address one or more of these challenges, and to enhance the rate of oxidation or reduction of species, which can potentially boost the performance of electrochemical devices such as batteries and fuel cells.

### SUMMARY OF THE INVENTION

In one aspect, an electrochemical cell is provided and can include a positive electrode having a catalyst comprising a plurality of nanoparticles with a charge voltage of less than about 3.9 V_{Li}. The electrochemical cell can be configured to catalyze reduction of metal oxides or oxygen during cell discharge and oxidize at least one metal-oxide species during cell charging. In some embodiments, the catalyst can include a first metal selected from the group of carbon, ruthenium, platinum, palladium, gold, manganese, iron, cobalt, nickel, copper, ruthenium, rhodium, silver, osmium, iridium, and alloys thereof. The catalyst can also include a first metal selected from the group of ruthenium, platinum, and palladium. In other embodiments, the catalyst can further include a second metal selected from the group of carbon, ruthenium, platinum, palladium, gold, manganese, iron, cobalt, nickel, copper, ruthenium, rhodium, silver, osmium, iridium, and alloys thereof. An atomic ratio of the first metal and the second metal can be in a range from about 100:1 to about 1:100. The positive electrode can additionally have a discharge voltage of greater than about 2.7 V_{Li} at or great than 100 mA/g_{catalyst}. The positive electrode can also have a discharge voltage of greater than about 2.7 V_{Li} at or great than 0.1 μA/cm²_{catalyst}. In some embodiments, the cell can be charged with a charge voltage of less than about 3.9 V_{Li} at a capacity higher than about 200 mAh/g_{catalyst}.

In another aspect, a metal-air electrochemical cell is provided and can include a positive electrode having a catalyst comprising a plurality of nanoparticles with a discharge voltage of greater than about 2.7 V_{Li} at or greater than 100 mA/g_{catalyst. The positive electrode can also have a discharge voltage of greater than about} 2.7 V_{Li} at or greater than 0.1 μA/cm²_{catalyst}. The positive electrode can additionally have a charge voltage of less than about 3.9 Vᵤ. In other embodiments, the positive electrode can have a charge voltage of less than about 3.9 V_{Li} at 200 mAh/g_{catalyst}. The electrochemical cell can be configured to catalyze reduction of metal oxides or oxygen during cell discharge and oxidize at least one metal-oxide species during cell charging. In some embodiments, the catalyst can include a first metal selected from the group of carbon, ruthenium, platinum, palladium, gold, manganese, iron, cobalt, nickel, copper, ruthenium, rhodium, silver, osmium, iridium, and alloys thereof. The catalyst can also include a first metal selected from the group of ruthenium, platinum, and palladium. In other embodiments, the catalyst can further include a second metal selected from the group of carbon, ruthenium, platinum, palladium, gold, manganese, iron, cobalt, nickel, copper, ruthenium, rhodium, silver, osmium, iridium, and alloys thereof. An atomic ratio of the first metal and the second metal can be in a range from about 100:1 to about 1:100.

In a further aspect, a metal-air electrochemical cell is provided and can include a positive electrode incorporating a catalyst comprising a plurality of bimetallic nanoparticles. The bimetallic nanoparticles can include first and second metals selected from the group of carbon, ruthenium, platinum, palladium, gold, manganese, iron, cobalt, nickel, copper, ruthenium, rhodium, silver, osmium, iridium, and alloys thereof. The catalyst can also include a first metal selected from the group of ruthenium, platinum, and palladium. The first and second metals can also be in the form of a core-shell structure. In some embodiments, the positive electrode can have a charge voltage of less about 3.9 V_{Li} and a discharge voltage of greater than about 2.7 V_{L}, at or great than 100 mA/g_{catalyst}. In other embodiments, the positive electrode can have a discharge voltage of greater than about 2.7 V_{Li} at or greater than 0.1 μA/cm²_{catalyst}. The positive electrode can also have a charge voltage of less than about 3.9 V_{Li} at 200 mAh/g_{catalyst}. The shell can have an average thickness of about one to about fifty atomic monolayers of the first metal. In some embodiments, the core can include a metal oxide and the shell can include a bimetallic material containing platinum, palladium, or ruthenium.

In one aspect, a method of catalyzing an electrochemical reaction in a metal-air electrochemical cell is provided and can include providing a source of metal at a negative electrode, providing a catalyst at a positive electrode, and catalyzing oxidation of at least one metal-oxide species during the application of a charging voltage of less than about 3.9 V_{Li}. In another embodiment, the method can include catalyzing oxidation of at least one metal-oxide species during the application of a charging voltage of less than about 3.9 V_{Li} at 200 mAh/g_{catalyst}. The first metal can be selected from the group of carbon, ruthenium, platinum, palladium, gold, manganese, iron, cobalt, nickel, copper, ruthenium, rhodium, silver, osmium, iridium, and alloys thereof. The catalyst can also include a first metal selected from the group of ruthenium, platinum, and palladium. In some embodiments, the catalyst can further include a second metal selected from the group of carbon, ruthenium, platinum, palladium, gold, manganese, iron, cobalt, nickel, copper, ruthenium, rhodium, silver, osmium, iridium, and alloys thereof.

In another aspect, a method of catalyzing an electrochemical reaction in a metal-air electrochemical cell is provided and can include providing a source of metal at a negative electrode, providing a catalyst at a positive electrode, and catalyzing reduction of metal oxides or oxygen at the positive electrode to generate a discharge voltage of greater than about 2.7 V_{Li} at or greater than 100 mA/g_{catalyst}. The positive electrode can also have a discharge voltage of greater than about 2.7 V_{Li} at or greater than 0.1 μA/cm²_{catalyst}. The first metal can be selected from the group of carbon, ruthenium, platinum, palladium, gold, manganese, iron, cobalt, nickel, copper, ruthenium, rhodium, silver, osmium, iridium, and alloys thereof. The catalyst can also include a first metal selected from the group of ruthenium, platinum, and palladium. In some embodiments, the catalyst can further include a second metal selected from the group of carbon, ruthenium, platinum, palladium, gold, manganese, iron, cobalt, nickel, copper, ruthenium, rhodium, silver, osmium, iridium, and alloys thereof.

In still further aspects, a metal-air electrochemical cell is provided and can include a positive electrode incorporating a catalyst comprising ruthenium-containing nanoparticles on a porous substrate, palladium-containing nanoparticles on a porous substrate, or platinum-containing particles on a porous substrate. The electrochemical cell can be configured to catalyze reduction of metal oxides or oxygen during cell discharge and to oxidize at least one metal-oxide species during cell charging. The nanoparticles can be characterized by a platinum atomic fraction, ruthenium atomic fraction, or palladium atomic fraction in a range from about 0.01% to 100%. In some embodiments, the catalyst can include a second metal selected from the group of carbon, ruthenium, platinum, palladium, gold, manganese, iron, cobalt, nickel, copper, rhodium, silver, osmium, iridium, and alloys thereof. The catalyst can further include an oxide of one or more of the metals. An atomic ratio of the ruthenium, palladium, or platinum and the second metal can be in a range from about 100:1 to about 1:100. A surface composition ratio of the ruthenium, platinum, and palladium, and the second metal can be in a range from about 20:1 to about 1:20.

### BRIEF DESCRIPTION OF THE DRAWINGS

Aspects of the present invention will be more fully understood from the following detailed description taken in conjunction with the accompanying drawings (not necessarily drawn to scale), in which:

FIG. 1A is a graph of the capacitive and IR-corrected net ORR mass-specific current densities of Pd/C, Pt/C, Ru/C, Au/C and C (all 0.05 mg_{carbon}/cm²_{disk}) in 0.1 MLiClO₄ DME during the negative-going scan; The measurements were done in three-electrode cells. Catalyst thin films and three-electrode cells were prepared as following. Glassy carbon disks (0.196 cm² disks; Pine, USA) were polished to a 0.05 μm mirror-finish before each experiment. Thin films of all the catalysts were prepared by drop-casting catalyst inks with a Nafion®/carbon weight ratio of 0.5/1 onto a glassy carbon disk, yielding a carbon loading of 0.05 mg_{carbon}/cm²_{disk}. The catalyst inks were composed of active catalysts, lithiated Nafion® (LITHion™ dispersion, Ion-Power, USA), and 20% 2-propanol (Sigma-Aldrich) in de-ionized water. The catalyst thin-films were subsequently dried in vacuum for 12 hours at 70° C. before testing. The three-electrode cell used for RDE measurements consists of a lithium-foil counter electrode embedded, a reference electrode based on a silver wire immersed into 0.1 M TBAPF₆ (Sigma-Aldrich) and 0.01 M AgNO₃ (BASi) in DME which was calibrated against Li metal (0 V_{Li}≈−3.61±0.02 V vs. Ag/Ag⁺), and a catalyst-covered glassy carbon disk as the working electrode.

FIG. 1B is the initial ORR region below 500 mA/g_{carbon} of FIG. 1A. This graph shows that Pd/C exhibits the highest ORR mass-specific activity followed by Pt/C, Ru/C, Au/C and carbon;

FIG. 2A is the capacitive and IR-corrected net ORR area-specific current densities of Pd/C, Pt/C, Ru/C, Au/C and C (all 0.05 mg_{carbon}/cm²_{disk}) in 0.1 MLiClO₄ DME during the negative-going scan. The measurement method is described in FIG. 1A;

FIG. 2B is the initial ORR region below 0.2 μA/cm²ₘₑₜₐₗ of FIG. 2A. This graph shows that Pd/C exhibits the highest ORR area-specific activity followed by Pt/C, Ru/C, Au/C and carbon;

FIG. 3A is a graphical volcano-relationship of the ORR potential at mass-specific current density of 100 mA/g_{carbon} and the oxygen binding energy (relative to Pt) for Pd/C, Pt/C, Ru/C, Au/C and C. This graph shows that the ORR mass-specific activity strongly correlates with the oxygen binding energy of the metal surface;

FIG. 3B is a graphical volcano-relationship of the ORR potential at area-specific current density of 0.2 μA/cm²ₘₑₜₐₗ and the oxygen binding energy (relative to Pt) for Pd/C, Pt/C, Ru/C, Au/C and C. This graph shows that the ORR area-specific activity strongly correlates with the oxygen binding energy of the metal surface;

FIG. 3C is a graphical rate comparison of the discharge voltage for various discharge rates compared with known electrodes normalized to the surface area of the catalyst. The discharge voltages of the reported literature were taken at the first ten percent of the discharge capacity. The area-specific current densities were obtained by considering the total current applied and the true surface area reported in the same study. The discharge voltage and the mass-specific current densities of Pd/C, Pt/C, Ru/C, Au/C and carbon were taken from high surface area RDE measurements shown in FIG. 2B. This graph shows that Pd/C, Pt/C, Ru/C and Au/C described in this invention exhibit higher discharge voltages based on area-specific discharge rates compared to that found in the reported literature;

FIG. 3D is a graphical rate comparison of the discharge voltage for various discharge rates compared with known electrodes normalized to the mass of the catalyst. The discharge voltages of the reported literature were taken at the first ten percent of the discharge capacity. The mass-specific current densities were obtained by considering the total current applied and the total catalyst loading reported in the same study. The discharge voltage and the mass-specific current densities of Pd/C, Pt/C, Ru/C, Au/C and carbon were taken from high surface area RDE measurements shown in FIG. 1B. This graph shows that Pd/C, Pt/C, Ru/C and Au/C described in this invention exhibit higher discharge voltages based on mass-specific discharge rates compared to the reported literature;

FIG. 4 is a schematic diagram of an electrochemical cell consistent with some embodiments of the present invention. The electrochemical cell body consists of tope stainless steel current collector, Teflon chamber and bottom stainless steel current collector. The top current collector consists of a gas purge inlet to the Teflon chamber and a gas purge outlet;

FIG. 5A is a graph of the Li-air cell discharge profiles of Pd/C, Pt/C, Ru/C, Au/C and C in the first cycle in 0.1 M LiClO₄ DME at 100 mA/g_{carbon}. Li—O₂ single-cells consisted of a lithium metal anode (15 mm in diameter and ˜0.45 mm thickness) and a Nafion®-bonded air electrode (12.7 mm diameter) using catalyst. Air electrode with a Nafion®/carbon weight ratio of 0.5/1 were prepared by coating ultrasonicated inks composed of catalyst, lithiated Nafion® (LITHion™ dispersion, Ion-Power, USA), and 2-propanol onto the separator (Celgard C480). After air-drying at 20° C. for 20 minutes, the cathodes were then subsequent vacuum-drying at 70° C. for 12 hours. The carbon loading for all air electrode were ranging from 0.5-0.6 mg_{carbon}. Li—O₂ cells were assembled in the following order: 1) placing a lithium foil onto the stainless steel current collector of the cell, 2) adding 20 μl electrolyte, 3) placing two pieces of the separator (Celgard C480) onto the lithium foil, 4) adding 20 μl electrolyte, 5) placing the air electrode onto the separator, 6) adding 20 μl electrolyte, 7) placing a current collector (316 stainless steel mesh and spring) on top, and, 8) purging the cell with pure oxygen for 5 minutes;

FIG. 5B is a graph of the initial ORR region below 100 mAh/g_{carbon} of FIG. 5A. This graph shows that Pd exhibits the highest discharge voltage followed by Ru/C, Pt/C, Au/C and carbon in Li—O₂ cells;

FIG. 5C presents Li-air single cell 2^{nd} discharge/charge profiles of Pt/C, Ru/C, and Pd/C. This graph shows that the high discharge activity of Pd/C is demonstrated in the subsequent cycle;

FIG. 6A is a graph of the X-ray diffraction (XRD) patterns of pristine and discharged electrodes supported on a Celgard 480 separator (100 and 2000 mA/g_{carbon}) for carbon. This graphs shows that lithium peroxide is the discharge product in discharged carbon electrode;

FIG. 6B is a graph of the XRD patterns of pristine and discharged electrodes supported on a Celgard 480 separator (100 and 2000 mA/g_{carbon}) for Au/C. This graphs shows that lithium peroxide is the discharge product in discharged Au/C electrode;

FIG. 7 is a graph of the potentiostatic charging profiles of Pt/C/Li₂O₂ electrodes in 0.1 M LiClO₄ DME. This graph shows that the Li₂O₂ decomposition rate on Pt/C increases as the holding potential increases, where 300 mA/g_{carbon} can be achieved at 3.9 V_{Li};

FIG. 8A is a graph of the activity of Li₂O₂ decomposition versus cell potential for Au/C, Pt/C and C in 0.1 M LiClO₄ DME. This graph shows that Pt/C exhibits the highest Li₂O₂ decomposition activity among Au/C, Pt/C and carbon in DME electrolyte;

FIG. 8B is a graph of the activity of Li₂O₂ decomposition versus cell potential for Au/C, Pt/C and carbon in 1 M LiClO₄ PC:DME (1:2 v/v). This graph shows that Pt/C exhibits the highest Li₂O₂ decomposition activity among Au/C, Pt/C and carbon in PC:DME electrolyte;

FIG. 9 is a graph of Li-air cell charge profiles of Pd/C, Pt/C, Ru/C, Au/C and C in the first cycle in 0.1 MLiClO₄ DME at 100 mA/g_{carbon}. This graph shows that Ru/C exhibits the highest OER activity followed by Pd/C, Pt/C, Au/C and carbon;

FIG. 10A is a graph of Li-air cell discharge/charge profiles of carbon and PtAu/C in the third cycle at 0.04 mA/cm²_{electrode} (100 mA/g_{carbon} for PtAu/C, 85 mA/g_{carbon} for carbon). This graph shows that PtAu/C can significantly enhance the round-trip efficiency from 60% (pure carbon) to 73%;

FIG. 10B is a graph of the background measurement during charging at 100 mA/g_{carbon} of an Ar and O₂-filled cell (charging first) for PtAu/C. This graph shows that the voltage at which the electrolyte decompose on PtAu/C in O₂ or Ar is higher than 4.0 V_{Li}. This demonstrates that the low charge voltage observed in FIG. 10A is resulted from the decomposition of the discharge products rather than electrolyte decomposition;

FIG. 11A is a representative transmission electron microscopy (TEM) image of PtAu/C. This graph shows the particle sizes of the PtAu/C particles are less than 10 nm;

FIG. 11B is a high-resolution TEM image of PtAu/C;

FIG. 12A is a graph of X-ray diffraction data of PtAu/C. This graph shows that single phase PtAu alloy was formed;

FIG. 12B is a graph of cyclic voltammograms of PtAu/C collected in Ar-saturated 0.5 M H₂SO₄ between 0.05 V-1.7 V vs. RHE (room temperature and 50 mV/s) with schematic representation of PtAu nanoparticles. This graph shows that both Pt and Au present on the surface of the PtAu nanoparticles;

FIG. 13 presents Li-air single cell 1^{st} discharge/charge profiles of carbon at 85 mA/g_{carbon}, Au/C, Pt/C, and PtAu/C at 100 mA/g_{carbon} compared with Li-air single cell discharge/charge profiles (1^{st} cycle) of PtAu/C at 50 mA/g_{carbon}, 100 mA/g_{carbon}, and 250 mA/g_{carbon}. This graph shows that Au is responsible for the discharge voltage of the PtAu/C and Pt is responsible for the charge voltage of the PtAu/C. In addition, the rate capability of PtAu/C shows that the charge voltage is sensitive to the current density;

FIG. 14 provides a graph of relative Pt fraction as a function of MOR activity in accord with some embodiments of the present invention;

FIGS. 15A-15D provide graphs of cyclic voltammetry performed for an oxygen reduction reaction using electrodes bearing AuPt nanoparticles having differing surface concentrations of platinum, in accord with some embodiments;

FIGS. 16A-16D provide graphs of cyclic voltammetry performed for the oxygen reduction reaction using rotating disk electrodes bearing AuPt nanoparticles having differing surface concentrations of platinum, in accord with some embodiments;

FIG. 17A provides a graph of applied potential versus measured current from an oxygen reduction reaction for electrodes bearing AuPt nanoparticles having differing surface concentrations of Pt;

FIG. 17B provides a graph of measured current from an oxygen reduction reaction versus Pt surface fraction of various AuPt nanoparticles on electrodes for an applied voltage of 0.9 volts versus RHE;

FIG. 18 provides a graph of the measured relative current at which CO is stripped as a function of applied potential vs. RHE using various surface concentrations of Pt on AuPt nanoparticles utilized as catalysts, in accord with embodiments of the present invention;

FIG. 19 presents a subset of the data of FIG. 18 showing measured relative current at which CO is stripped as a function of Pt surface fraction of the AuPt nanoparticles for various applied voltages relative to RHE;

FIG. 20A presents a graph of applied voltage vs. RHE as a function of measured current from a CO oxidation reaction using various Pt surface concentrations of AuPt nanoparticles where the data is not background corrected;

FIG. 20B presents a graph of applied voltage vs. RHE as a function of measured current from a CO oxidation reaction using various Pt surface concentrations of AuPt nanoparticles where the data is background corrected;

FIG. 21A presents a subset of the data in FIG. 20A showing measured current from a CO oxidation reaction as a function of Pt surface fraction of AuPt nanoparticles for various applied voltages vs. RHE; and

FIG. 21B presents a subset of the data in FIG. 20B showing measured current from a CO oxidation reaction as a function of Pt surface fraction of AuPt nanoparticles for various applied voltages vs. RHE.

### DETAILED DESCRIPTION

Methods and devices for catalyzing reactions in a metal-air electrochemical cell are disclosed. In some instances, a porous positive electrode of the metal-air electrochemical cell includes a metal to catalyze a reaction at the electrode (e.g., oxidation of one or more lithium-oxide species). The metal can be disposed as nanoparticles, and/or can be combined with a second metal. Use of such catalytic materials can potentially improve the performance of electrochemical cells, for example by improving the discharge potential of the cell, lowering the charging potential of the cell, improving the round-trip efficiency of the cell (i.e., the ratio of the discharge potential to the charging potential), increasing the output current upon discharge, and/or increasing the output capacity of the cell.

Further embodiments of the invention are directed to devices and methods that can generally promote chemical reactions (e.g., an oxidation/reduction reaction), and which can optionally function as a portion of an electrochemical cell such as the materials utilized in the metal-air electrochemical cells disclosed herein. Accordingly, embodiments can be directed to the nanoparticles, catalysts, loaded substrates, electrodes, portions of electrodes, and any combination of structures that can be utilized to promote a chemical reaction.

For instance, nanoparticles as described herein can be utilized in applications beyond the context of electrochemical cells and/or to promote molecular oxygen evolution and/or reduction. As an example, nanoparticles can be configured as a catalyst for promoting a chemical reaction (e.g., an oxidation/reduction reaction). Such catalysts can enhance the rate of the chemical reaction relative to commercial catalysts when the catalyst contacts a reactant, for instance. The particles can be distributed on a substrate such as a porous substrate. Methods of synthesizing these nanoparticles, and tailoring the atomic fraction of a metal on the nanoparticle surface, are also within the scope of the present invention.

Unless otherwise specified, the following terms will be accorded the meanings disclosed below. As utilized herein, the term “air” refers to an electrochemical cell that utilizes oxygen at the positive electrode for an electrochemical reaction. Accordingly, the oxygen can be disposed as air, but can also be disposed as any other fluid that includes molecular oxygen.

As utilized herein, the phrase “metal-air” when describing electrochemical cells refers to such cells where oxygen is utilized at the positive electrode of the cell. Metals useful as the negative electrode in metal-air electrochemical cells include lithium and other alkali metals, such as sodium and potassium, as well as similar compositions, such as zinc, aluminum, and carbon in some applications. In addition, the term encompasses metal containing materials, including non-metallic materials, such as silicon, having atomic metal species contained and/or dispersed therein.

As utilized herein, the phrase “core-shell structure” refers to a structure having an exterior surface and an inner structure that is at least partially covered by the exterior surface. Accordingly, a core-shell structure need not have the “shell” encapsulate the “core.” For instance, the core-shell structure can be embodied as a lamellae structure with an exterior surface and an inner layer. As well, the core-shell structure can be embodied as a bilayer covering an inner substrate superstructure.

The phrase “electrochemical oxidation” will be used to refer to when the neutral metal atom (e.g., Li contained in Li₂O₂ at the positive electrode) is ionized to become a Li⁺ ion and an electron during charge of the metal-air battery. Further, the phrase “electrochemical reduction” refers to the reverse process when Li⁺ ions migrating from the metal-containing negative electrode react with O₂ at the positive electrode to become Li₂O₂ during discharge.

The term “g_{electrode}” refers to the total mass of electroactive material within a fully discharged positive electrode, including carbon and discharge products such as lithium peroxide or lithium oxide, and may also include the mass of catalyst contained within an electrode. Similarly, the phrase “g_{carbon}” refers to the total mass of the carbon utilized in the electrode.

Finally, the phrase “positive electrode” will be used to characterize the NF electrode that is exposed to oxygen/air. The term “negative electrode” will be used to characterize the metal electrode that will donate metal ions during discharge.

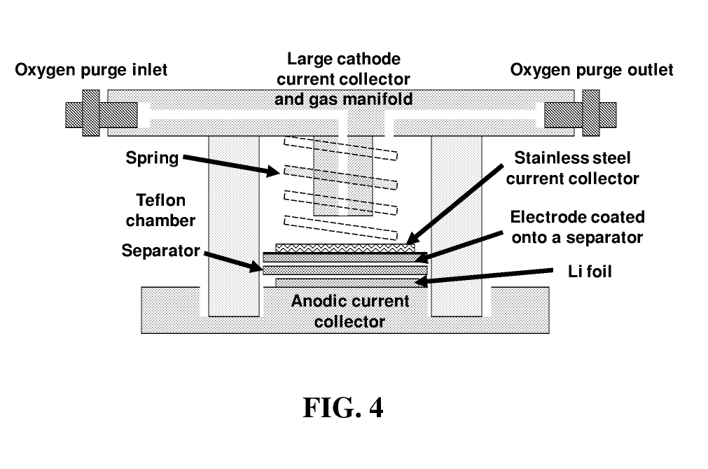

Some embodiments of the invention are directed to an electrochemical cell that can exhibit enhanced performance. A schematic of one particular embodiment of such a cell is shown in FIG. 4, depicting a lithium-air battery. Oxygen gas can be inserted into the cell to contact a positive electrode current collector and a positive electrode, the latter being coated onto a separator. A lithium foil is utilized as a source of lithium metal and the anode, which contacts an anode current collector. An aprotic solvent can be isolated in the Teflon chamber. Discharge of the cell results in dissolution of the lithium metal at the foil, reduction of oxygen, and deposition in the form of an oxide (e.g., LiO₂ and/or Li₂O₂), and the flow of electrons to the positive electrode current collector. Charging of the cell can result in oxidation of one or more lithium oxide species.

It is understood that while the electrochemical cell of FIG. 4 embodies some aspects of the present invention, other configurations can also be utilized including those known to one skilled in the art. For instance, lithium foil need not be utilized as the anode. Indeed, any suitable anode can be utilized with the cell. As well, the positive electrode can be embodied in a variety of forms. In some embodiments, the positive electrode is a porous substrate, which can exhibit high surface area to promote electrochemical reaction. For instance, the porous substrate can be a carbon-based material such as a fused carbon-polymer beaded structure that can act as a suitable conductor. It is well understood that other substrates can also be utilized.

In other embodiments, it can be desirable to evaluate the intrinsic electrocatalytic activity of various catalysts for use in rechargeable Li-air batteries. In such cases, a thin film of a particular catalyst can be dispersed on a glassy carbon rotating disk electrode (RDE). Employing such thin films to study oxygen reduction reaction (ORR) kinetics essentially eliminates all undefined mass-transport resistances. In addition, this technique reduces the amount of catalyst required for testing and simplifies the testing procedure. Details of the technique are outlined below in the Example section under “Rotating Disk Electrode Experiments.”

In some embodiments, the positive electrode includes a catalyst for promoting/catalyzing an electrochemical reaction at the positive electrode. The catalyst can include at least a first metal of carbon, ruthenium, platinum, palladium, gold, manganese, iron, cobalt, nickel, copper, ruthenium, rhodium, silver, osmium, iridium, and alloys thereof, which can be disposed in a variety of forms. For example, the first metal can form at least a portion of nanoparticles, which can be at least partially disposed at the surface of the positive electrode (e.g., on the surface of a substrate). In some embodiments, use of a catalyst including a first metal in an electrochemical cell can result in enhanced performance of the electrochemical cell relative to commercial and/or known catalysts. For example, use of a catalyst having a first metal in a metal-air electrochemical cell can result in enhanced charging and/or discharge performance of the cell.

In another embodiment, an exemplary catalyst can include a first metal and a second metal that is different from the first metal. The second metal can be any of carbon, ruthenium, platinum, palladium, gold, manganese, iron, cobalt, nickel, copper, ruthenium, rhodium, silver, osmium, iridium, and alloys thereof. Catalysts of this form can enhance the performance of an electrochemical cell in a variety of manners as documented herein.

Nanoparticles utilized in some embodiments of the invention can be dimensioned such that they can serve as a coating on a porous substrate to distribute the first metal and/or the second metal. For instance, the nanoparticles can have a size in the range of about 5 nm to about 10 nm while being distributed on a porous substrate comprising, for example, fused carbon-based particles having a size of greater than about 50 nm. In some embodiments, the catalyst nanoparticles can be in a size range of about 1 nm to about 100 nm, about 10 nm to about 100 nm, about 50 nm to about 100 nm, about 1 nm to about 50 nm, and/or about 1 nm to about 10 nm.

Embodiments that utilize a catalyst having a first metal and a second metal that is different from the first metal can utilize an atomic ratio of the first metal to the second metal in a range from about 100:1 to about 1:100. The surface composition ratio of the first metal and the second metal can range from about 20:1 to about 1:20. In some embodiments, the disposition of the second metal can be an oxide, such as iron oxide, nickel oxide, manganese oxide, and copper oxide, though others can also be utilized. In some instances, the first metal and the second metal can exhibit signs of forming an alloy-like molecular structure. In some embodiments, the ratios noted above can apply to the presence of the two or more metals at a surface of the nanoparticle.

In some instances, the presence of multiple metal species can result in the manufacture of an electrode with enhanced performance relative to the use of particles with a particle surface having a single metal as the only metal species present. The term “bimetallic” as used herein is intended to cover two or more component systems, e.g., compositions of three, four or more metals as well as two metal compositions.

In some embodiments where two or more metals are utilized as a catalyst, the metals can be disposed in a core-shell structure. For example, nanoparticles can be embodied in a core-shell structure where the core can be the second metal and the shell can be the first metal. In another example, an inner substrate can be coated with a “core” that comprises the second metal, which can be at least partially coated by a shell that can comprise the first metal. For instance, the shell can be a several monolayer thick coating of the first metal (e.g., a monolayer to about 50 monolayers thick, or greater). In yet another example, a positive electrode substrate framework can be at least partially coated by a “core” layer that includes the second metal with the “core” layer being at least partially coated by a material comprising the first metal. In some embodiments, the “shell” can include two or more metals.

Nanoparticle formation can occur by any number of techniques, including utilizing techniques known to those of ordinary skill in the art. In some embodiments, nanoparticles with multiple metal species are formed by reacting precursors having multiple metal-containing species, either in molecules that individually contain the metal species or in combination, in the presence of an amphiphilic solvent (e.g., oleylamine), which can optionally act as a stabilizer and/or reducing agent for at least one of the metal species. Such synthetic routes can optionally involve a one-step reaction method, which can conveniently form nanoparticles.

In other embodiments of the invention, methods of tuning multi-metal nanoparticles by restructuring the surface morphology and/or composition are disclosed to improve catalyst's activity and selectivity. For example, post-synthetic adjustments of the surface composition of multimetal particles are disclosed as a strategy to further improve the nanoparticles catalytic behaviors. By manipulating the temperature and the atmosphere (e.g., oxygen content) during heat treatment of nanoparticles, which can originate with the same bulk composition, modification of the surface composition can be optimized for nanoparticle customization.

Other embodiments are directed to methods of catalyzing an electrochemical reaction in a metal-air electrochemical cell. Such methods can utilize any of the cell components, or portions of cell components, described in the present application. For instance, some embodiments can provide for a source of metal or other material capable of oxidation at an anode. Catalyst can be disposed on the surface of a positive electrode, which can be consistent with any of the embodiments discussed herein (e.g., platinum in the form of nanoparticles and/or platinum along with a second metal). Oxygen can be delivered to the positive electrode, and reduction of the oxygen can be catalyzed by the catalyst. In some instances, catalyzation of the oxidation of one or more metal-oxide species can take place at the positive electrode.

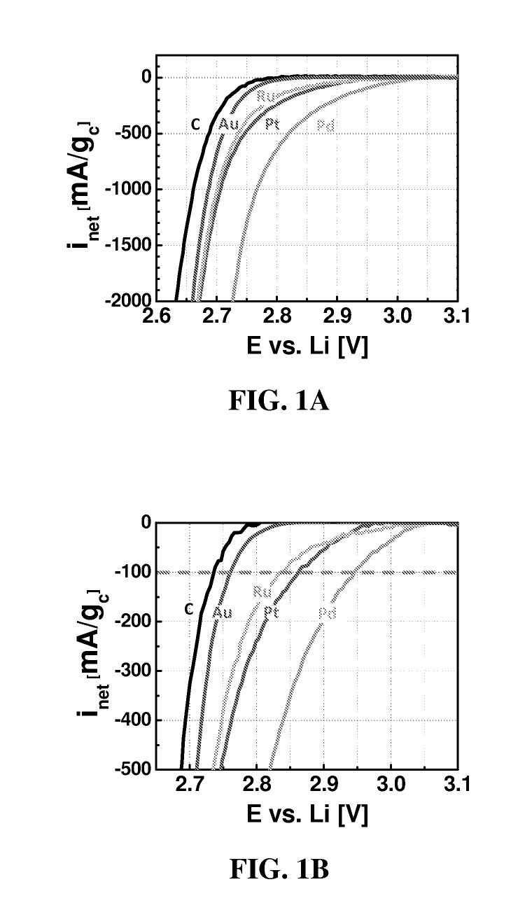

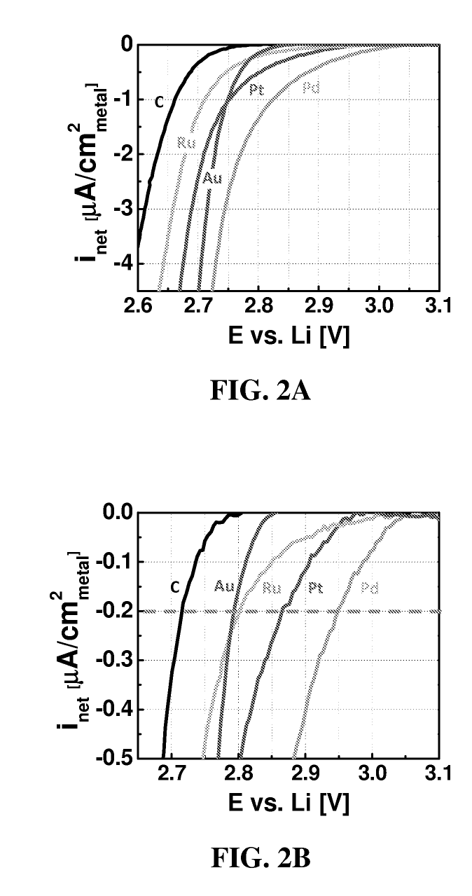

In one embodiment, the capacitive and IR-corrected net ORR mass-specific current densities of Pd/C, Pt/C, Ru/C, Au/C and C were examined as shown in FIGS. 1A-2B. The experimental details for the generation of the data in these figures are noted below under “Rotating Disk Electrode Experiments.” FIG. 1A shows the discharge voltage for each of the five catalysts versus applied current, normalized to the mass of the carbon in the electrode. FIG. 1B is a magnified portion of FIG. 1A. All of the catalysts demonstrated a discharge voltage greater than about 2.7 V_{Li} at 100 mA/g_{carbon} applied current, and Pd, Pt, and Ru demonstrated a discharge voltage above 2.8 V_{Li} at 100 mA/g_{carbon}. Pd demonstrated the highest discharge voltage, followed by Pt, Ru, Au, and C. FIG. 2A illustrates the same data as in FIGS. 1A and 1B normalized to the surface area of the catalyst particles, while FIG. 2B is a magnified portion of FIG. 2A. Again, Pd demonstrated the highest discharge voltage, followed by Pt, Ru, Au, and C, with all catalysts demonstrating a discharge voltage greater than 2.7 V_{Li} at 0.2 μA/cm²ₘₑₜₐₗ.

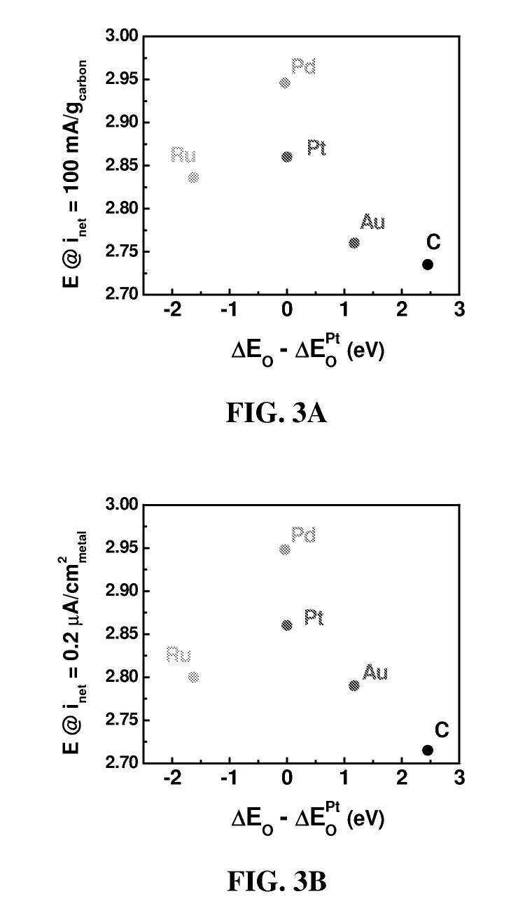

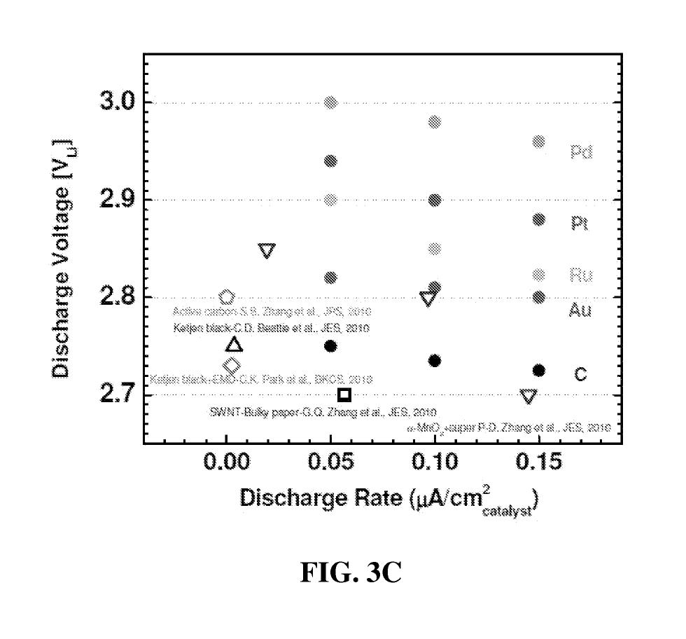

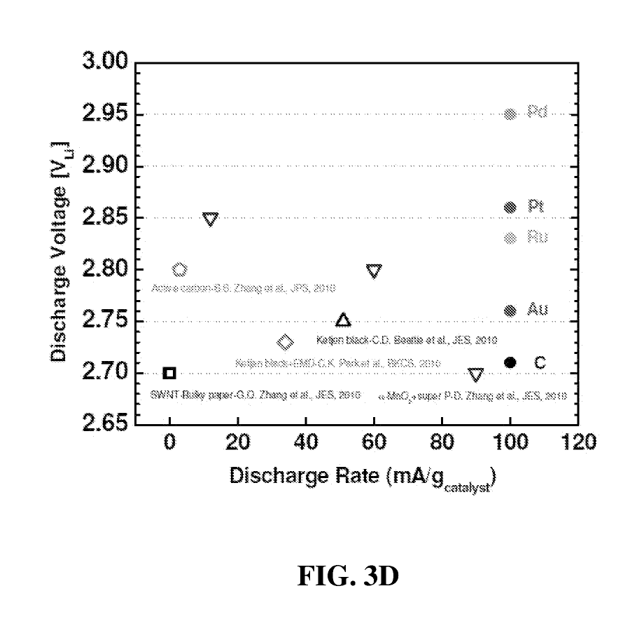

FIGS. 3A and 3B illustrate a “volcano” relationship of the ORR potential at a mass-specific current density of 100 mA/g_{carbon} and at an area-specific current density of 0.2 μA/cm²ₘₑₜₐₗ, respectively, and the oxygen binding energy (relative to Pt) for Pd/C, Pt/C, Ru/C, Au/C and C. FIGS. 3A and 3B illustrate two important points. First, these figures show which catalysts demonstrate the highest activity and highest discharge voltage, namely, Pd followed by Pt, Ru, Au, and C. Second, they show that the catalytic activity at the electrode is controlled by the binding energy of oxygen. In particular, the closer the binding energy is to 0, the higher the catalytic activity of the particular catalyst. It should also be noted that carbon is demonstrated as a good catalyst when compared with the other noble metals, Pd, Pt, Au, and Ru.

A comparison of the discharge characteristics of Pd, Pt, Ru, Au, and C with the performance of known electrodes is shown in FIGS. 3C (normalized to the surface area of the catalyst) and 3D (normalized to the mass of the catalyst). As shown, the currently disclosed catalysts demonstrated significantly better performance than known electrodes. In particular, Pd, Pt, and Ru demonstrated better discharge voltages per discharge rate than all known electrodes.

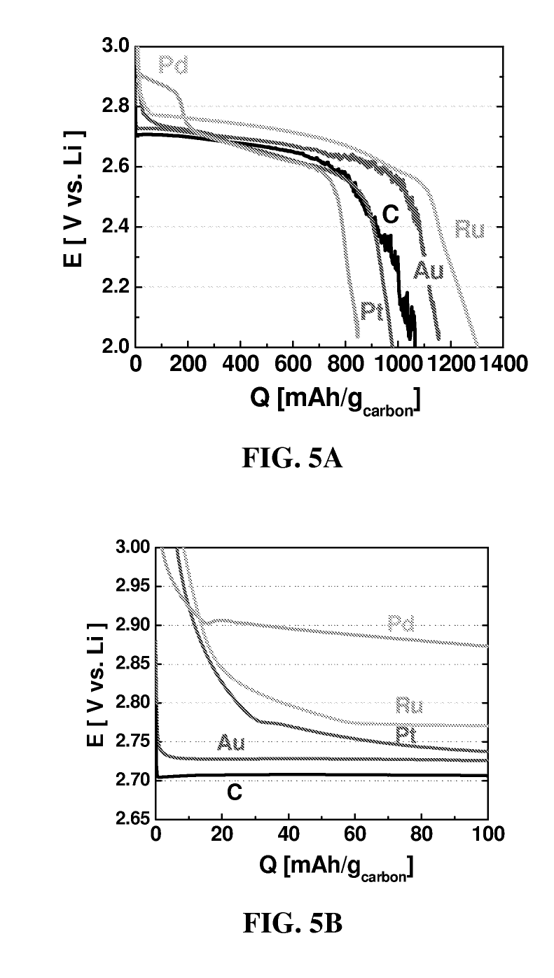

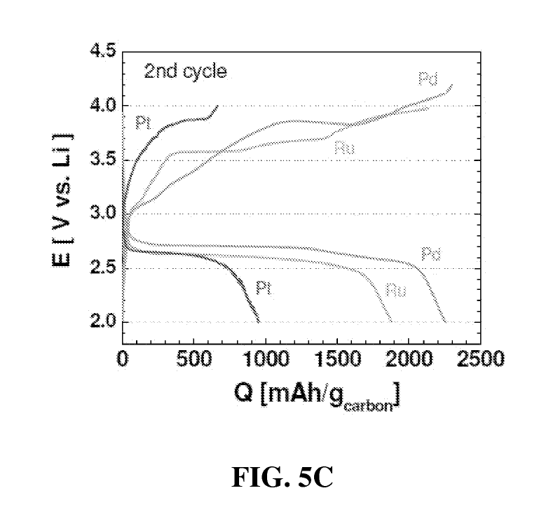

FIG. 5A shows the Li-air cell discharge profiles of Pd/C, Pt/C, Ru/C, Au/C and C in the first cycle in 0.1 MLiClO₄ DME at 100 mAh/g_{carbon}. FIG. 5B shows a magnified portion of FIG. 5A, in particular of the initial ORR region below 100 mAh/g_{carbon}. While Pd initially demonstrates a lower discharge voltage than Ru and Pt below about 20 mAh/g_{carbon}, it remains higher than the other catalysts above 2.85 V_{Li} after about 20 mAh/g_{carbon}. FIG. 5C compares the discharge/charge profiles of Pt/C, Ru/C, and Pd/C.

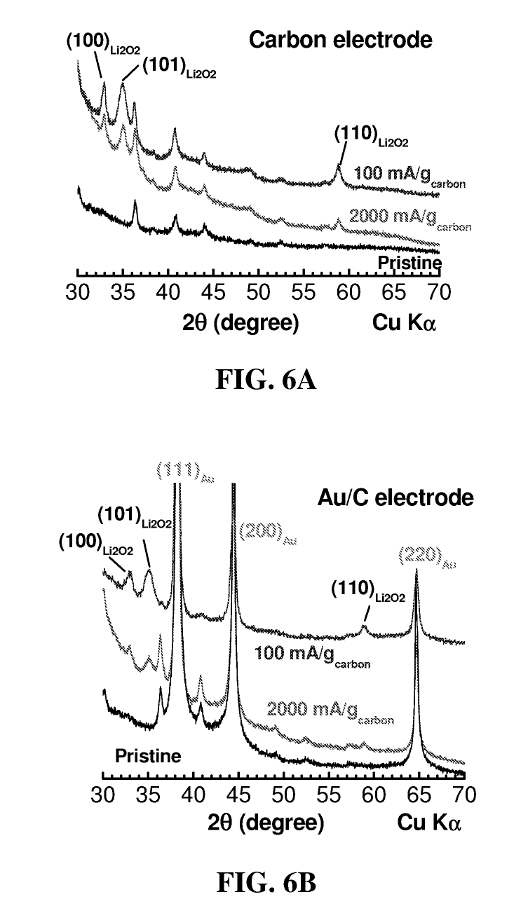

FIG. 6A illustrates XRD patterns of pristine and discharged electrodes supported on a Celgard 480 separator (100 and 2000 mA/g_{carbon}) for carbon, while FIG. 6B shows XRD patterns of pristine and discharged electrodes supported on a Celgard 480 separator (100 and 2000 mA/g_{carbon}) for Au/C. As shown, Li₂O₂ is the primary discharge product in the Li-air electrochemical cell.

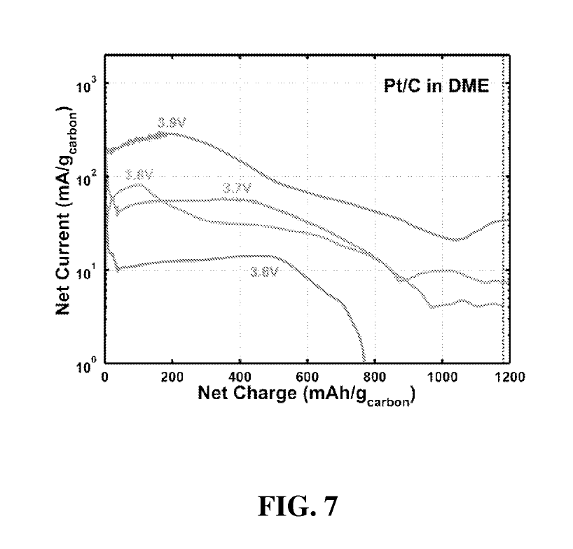

FIG. 7 shows the potentiostatic charging profiles of Pt/C/Li₂O₂ electrodes in 0.1 M LiClO₄ DME. This graph shows that the Li₂O₂ decomposition rate on Pt/C increases as the holding potential increases, where 300 mA/g_{carbon} can be achieved at 3.9 V versus lithium.

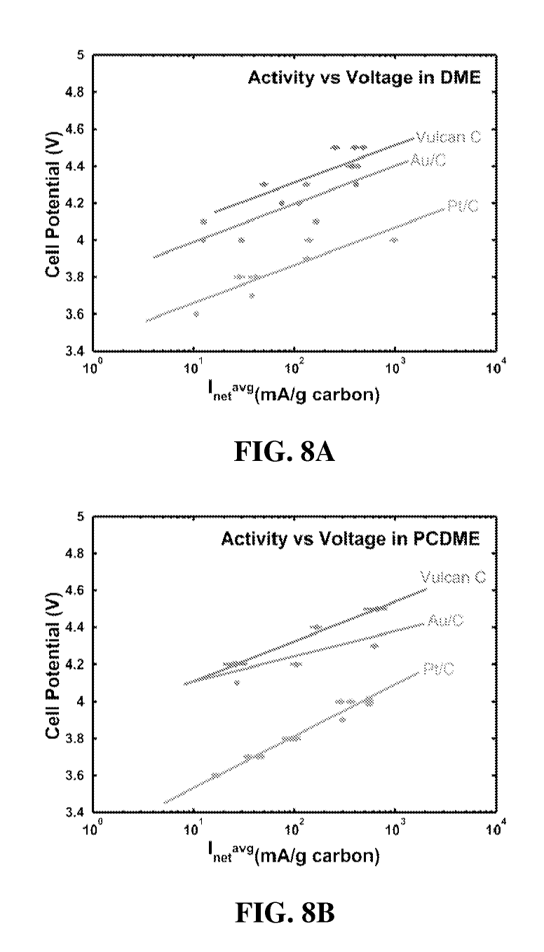

FIG. 8A shows the activity of Li₂O₂ decomposition versus cell potential for Au/C, Pt/C and carbon in 0.1 M LiClO₄ DME, while FIG. 8B shows the activity of Li₂O₂ decomposition versus cell potential for Au/C, Pt/C and carbon in 1 M LiClO₄ PC:DME (1:2 v/v). Pt demonstrated the lowest charging voltage in both cases.

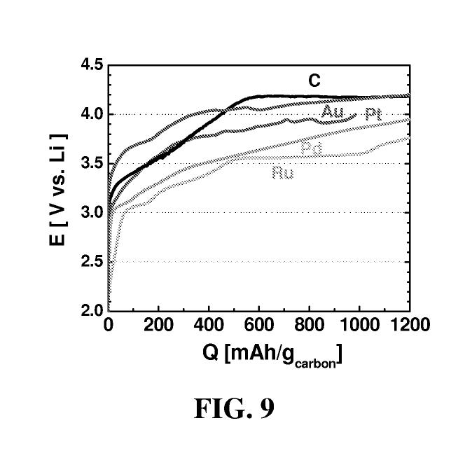

FIG. 9 is a comparison of the Li-air charging profiles of Pd/C, Pt/C, Ru/C, Au/C and C in the first cycle in 0.1 MLiClO₄ DME at 100 mA/g_{carbon}. All of the catalysts demonstrated charging voltages below about 4.0 V_{Li} below about 300 mAh/g_{carbon}. As shown, Ru demonstrated the lowest charging voltage, followed by Pd and Pt.

### EXAMPLES

The following examples are provided to illustrate some embodiments of the invention. The examples are not intended to limit the scope of any particular embodiment(s) utilized.

### Rotating Disk Electrode Experiments

All experiments were conducted in 0.1 M LiClO₄ in DME electrolyte, from Novolyte, USA (all <20 ppmH2O) at room temperature.

Catalyst thin films and three-electrode cells were prepared according to the following for each of Pd, Pt, Au, Ru, and C. Glassy carbon disks (0.196 cm² disks; Pine, USA) were polished to a 0.05 μm minor-finish before each experiment. Thin films of pure Vulcan XC-72 or 40 wt % [catalyst]/Vulcan (i.e., 40 wt % Pd/Vulcan, 40 wt % Pt/Vulcan, 40 wt % Au/Vulcan, and 40 wt % Ru/Vulcan) were prepared by drop-casting catalyst inks with a Nafion/carbon weight ratio of 0.5/1 onto a glassy carbon disk, yielding carbon loadings ranging from 0.05 mg_{carbon}/cm²_{disk}. The catalyst inks were composed of Vulcan or [catalyst]/Vulcan, lithiated Nafion (LITHion dispersion, Ion Power, USA), and 20% 2-propanol (Sigma-Aldrich) in deionized water. The catalyst thin-films were subsequently dried in vacuum for 12 hours before testing. A three-electrode cell was used with the RDE and consists of a lithium-foil counter electrode, a reference electrode based on a silver wire immersed into 0.1 M TBAPF₆ (Sigma-Aldrich) and 0.01 M AgNO₃(BASi) in DME (1:2 v/v) which was calibrated against Li metal (0 V_{Li}˜−3.61±0.02 V vs. Ag/Ag⁺), and a catalyst-covered glassy carbon disk as the working electrode.

The working electrode was immersed into the Ar or O₂-purged electrolyte for 30 min prior to each cyclic voltammetry (CV) experiment. The first scan CV in this study is defined as follows: after steady-state CVs were obtained in Ar, the cell was purged with O₂ for 20 min, and then the potential was scanned from 3.5 V_{Li} to the low voltage limit, followed by a voltage scan to the upper potential limit of 4.4 V_{Li} and then back to 3.5 V_{Li}. The IR-correction to remove ohmic losses was performed by considering a total cell resistance of ˜3.5 KΩ measured by AC impedance. The capacitive corrected ORR currents were obtained by subtracting the current measured under Ar from that found in pure oxygen under identical scan rates, rotation speeds, and catalyst loadings.

Li-air single-cells consisted of a lithium metal anode (15 mm in diameter and ˜0.45 mm thickness) and a Nafion-bonded cathode (12.7 mm diameter) using either pure Vulcan XC-72 or 40 wt % [catalyst]/Vulcan. Cathodes with a Nafion/carbon weight ratio of 0.5/1 were prepared by coating ultrasonicated inks composed of catalyst, lithiated Nafion (LITHion dispersion, Ion-Power, USA), and 2-propanol onto the separator (Celgard C480). After air-drying at 20° C. for 20 min, the cathodes were then subsequent vacuum-drying at 70° C. for 12 h. The carbon loading for pure Vulcan and 40 wt % [catalyst]/Vulcan electrode was 0.5 mg_{carbon} (0.39 mg_{carbon}/cm²_{electrode}) and 0.45 mg_{carbon} (0.35 mg_{carbon}/cm²_{electrode}), respectively. The Li-air cells were discharged galvanostatically (Solartron 1470) at 0.04 mA/cm²_{electrode} (corresponding to ˜100 mA/g_{carbon} for Vulcan and ˜110 mA/g_{carbon} for 40 wt % [catalust]/Vulcan) with a low voltage limit of 2.0 V_{Li}.

### Synthesis and Characterization of Pt/Au Nanoparticulate-Based Electrode

PtAu nanoparticles were synthesized by reducing HAuCl₄ and H₂PtCl₆ in oleylamine and then loaded onto Vulcan carbon (XC-72) to yield 40 wt % PtAu/C. 0.25 mmol HAuCl₄ (Sigma-Aldrich) and 0.25 mmol H₂PtCl₆ (Sigma-Aldrich) were dissolved in 20 mL oleylamine (Sigma-Aldrich) at 40° C. under an Ar blanket. The solution was then heated up to 160° C. and maintained at 160° C. for 2 h. PtAu particles were collected by adding 100 mL ethanol and following centrifugation. The as-prepared PtAu nanoparticles were dispersed then in non-polar solvents such as hexane and toluene. The catalyst was thermally treated at 250° C. in dry air to remove the nanoparticle surfactant before battery assembly.

Preparation of the carbon substrate and thermal treatment were as follows. 150 mg Vulcan XC-72 (Premetek, USA) were pre-dispersed in 400 mL hexane (Sigma-Aldrich) by sonicating in ice bath for 5 h. As-prepared PtAu nanoparticles (−100 mg) were dissolved in hexane and then added dropwise into the Vulcan solution under sonication in ice bath. The solution was further sonicated for 2 h and stirred overnight. The catalyst powders were collected by purging Ar (evaporating hexane) at room temperature and dried in vacuum for 24 hours. The PtAu/C catalyst was finally treated at 250° C. in dry air for 30 min to remove surfactant yielding 40 wt. % PtAu/C, which is determined by thermogravimetric analysis (TGA).

Electrodes with a Nafion®/carbon weight ratio of 0.5/1 were prepared by drop-casting ultrasonicated inks composed of carbon or catalyst, Nafion® dispersion (DE520, Ion-Power, USA), and 20 wt. % 2-propanol (Sigma-Aldrich) in de-ionized water (18.2 MS·cm, Millipore) onto the glassy carbon disk, yielding a carbon loading of 0.2 mg/mL. An air-electrode with a Nafion®/carbon weight ratio of 0.5/1 were prepared by coating ultrasonicated inks composed of catalyst, lithium-ion-exchanged Nafion® dispersion (Ion-Power, USA), and 2-propanol (Sigma-Aldrich) onto the separator (Celgard C480). The electrodes were air-drying at 20° C. for about 20 minutes and subsequent vacuum-drying for 3 hours.

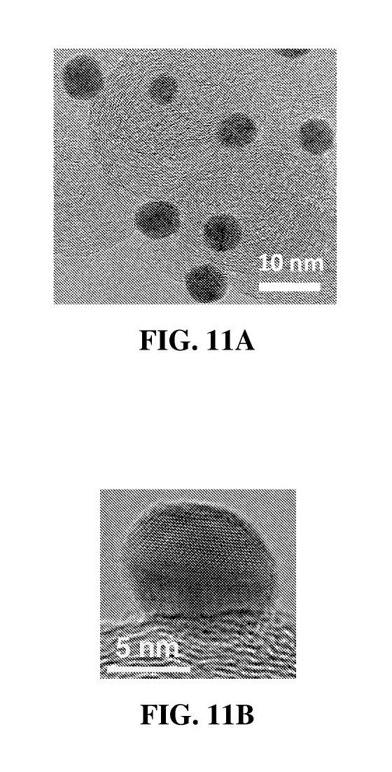

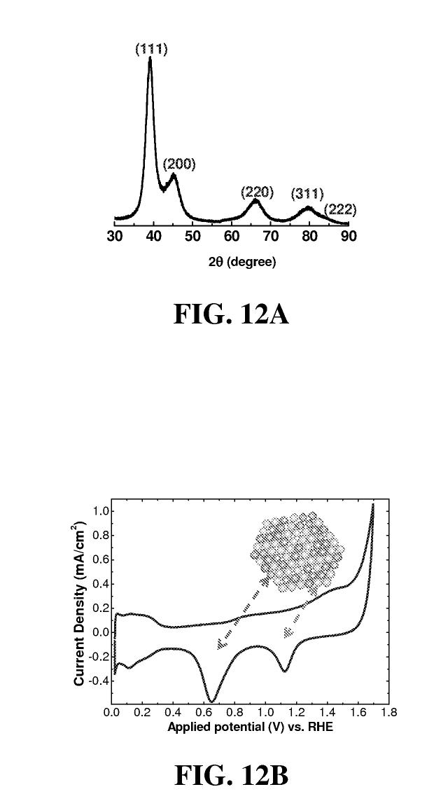

Transmission electron microscopy (TEM) shows that PtAu nanoparticles are uniformly distributed on carbon (FIG. 1(a)), having a number-averaged particle size of 6.8±1.4 nm, and a volume-averaged diameter of 7.3 nm (yielding a dispersion of 40 m²/g_{Aupt}). In addition, X-ray diffraction data of PtAu/C indicate that Pt and Au atoms form a solid-solution (FIG. 12A), which is in agreement with previous reported powder diffraction file (PDF#01-074-5396) database for Pt_{0.5}Au_{0.5}. This is further supported by energy-dispersive X-ray (EDX) mapping by scanning transmission electron microscopy revealing Pt and Au atoms distributed uniformly within individual particles, as shown in FIGS. 11A and 11B.

Cyclic voltammetry (CV) methods were used to obtain the electrochemical surface area (ESA) of Pt and Au of PtAu nanoparticles, from which surface atomic fractions can be estimated. The ESA of Pt and Au were estimated from the charge associated with hydrogen desorption/desorption with that with the formation of AuO or Au(OH)₂ in the CV data in FIG. 12B, respectively. The specific ESA is 38±4 m²/g_{AuPt}, which is reasonable agreement with the dispersion estimated from TEM data. Surface atomic ratio of Pt/Au was found to be (60±2%)/(40±2%) which is in good agreement with the average particle composition obtained from EDX (Pt 56±5% and Au 44±5%).

### Testing of Catalytic Activity of the Pt/Au Nanoparticulate-Based Electrode

The electrocatalytic activity of PtAu/C for ORR and OER were examined in Li-air cells, which was compared with those of pure carbon (Vulcan XC-72), Pt/C and Au/C (Premetek, 40 wt % on Vulcan XC-72). Cell configuration and the making of air electrodes are reported in the materials appended with the present application. All air electrodes had very comparable carbon-loadings. Catalyzed-carbon catalysts (i.e., 40 wt % Pt/C, 40 wt % Au/C and 40 wt % PtAu/C) had carbon-loadings of 0.50±0.02 mg. Pure carbon electrodes had carbon-loadings of 0.65±0.11 mg over an area of 1.27 cm². The thicknesses for all the air electrodes were 14 μm±2 μm. As the metal volume fraction was negligible and the void volume fraction of catalyzed and non-catalyzed air electrodes was essentially the same, all air electrodes were expected to have similar void volume for LiₓO₂ storage.

The discharge and charge voltages of Li-air cells can be influenced greatly by PtAu nanoparticles used in the air electrode. While FIG. 2(a) shows that Li-air cells of PtAu/C and pure carbon exhibited similar specific capacities (≈1200 mAh/g) at 0.04 mA/cm²_{electrode} (˜100 mA/g_{carbon} for PtAu/C, ˜85 mA/g_{carbon} for pure carbon), air electrodes with PtAu/C had a higher round-trip efficiency than that with carbon only. During discharge (ORR), the discharge voltage of PtAu/C was consistently higher than pure carbon by ≈360−150 mV. During charge (OER), the charge voltages of PtAu/C fell in the range from 3.4 V_{Li} to 3.8 V_{Li} (with an average of ≈3.6 V_{Li}), which is substantially lower (by 900 mV) than that of pure carbon (with an average voltage of ≈4.5 V_{Li}).

In order to verify that the charging current of voltages lower than 4 V_{Li} is not a result of electrolyte decomposition, cells were charged under both Ar and O₂. The charge associated with electrolyte decomposition on PtAu/C became significant at voltages ≧4.0 V_{Li}, proving that PtAu/C catalyzes the oxidation of lithium (per)oxide discharge products at voltages as low as 3.4 V_{Li}. The round-trip efficiency of the PtAu/C positive electrode in Li-air cells was 73%, which is much improved relative to 57% found for the pure carbon positive electrode.

The PtAu/C catalyst exhibits considerably lower charging voltages than MnOₓ/C (≈4.2_{Li}), λ-MnO₂, α-MnO₂ nanotubes, and CO₃O₄ (≈4.0 V_{Li}) at a comparable current density of 70 mA/g_{carbon}. Moreover, PtAu/C shows higher OER activity, having a charging capacity of over 500 mAh/g_{carbon} at ≦3.6 V_{Li} and 0.04 mA/cm²_{electrode compared to pyrolyzed cobalt phthalocyanine supported on carbon delivering ≈}60 mAh/g_{carbon} below 3.6 V_{Li} at 0.05 mA/cm²_{electrode}.

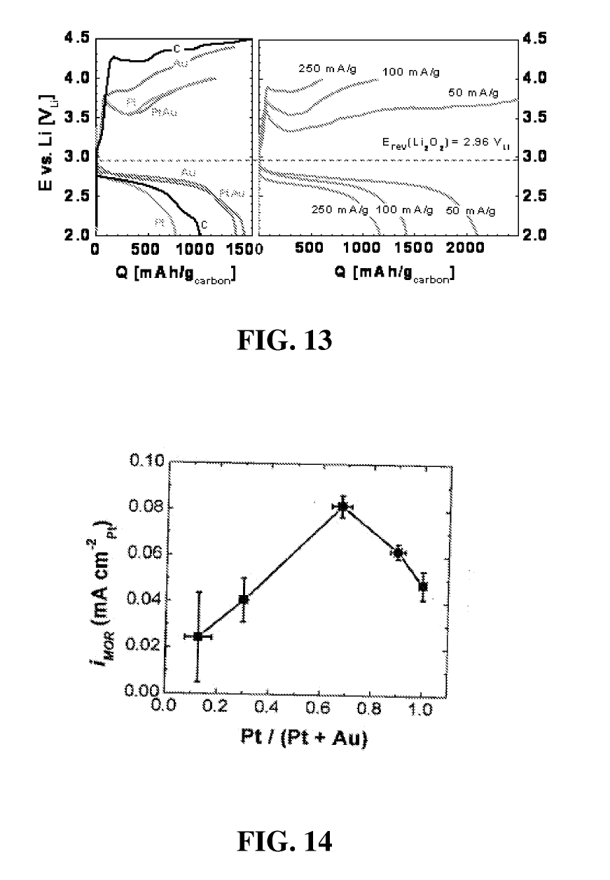

In order to understand the roles of surface Pt and Au atoms of PtAu/C in catalyzing ORR and OER kinetics, first discharge and charge voltages of Li-air cells with PtAu/C were compared with those with Pt/C and Au/C at 100 mA/g_{carbon}, as shown in FIG. 13. The discharge voltages with PtAu/C are comparable to those with Au/C while charging voltages with PtAu/C are comparable to those with Pt/C. This result indicates that surface Pt and Au atoms on PtAu/C are responsible for ORR and OER kinetics, respectively. Therefore, PtAu/C demonstrates bifunctional catalytic activity for ORR and OER in Li-air cells. Interestingly, the charging voltages of PtAu/C became lower than Pt/C in subsequent cycles, which were reproducible over multiple cells.

The effect of current densities on the discharge and charge voltages of Li-air cells with PtAu/C were investigated. With decreasing current densities, the difference between discharge and charge voltages was reduced considerably, as shown in FIG. 13. Remarkably, at 50 mA/g_{carbon}, Li-air cells with PtAu/C can deliver ≈50% (≈1000 mAh/g_{carbon}) of the discharge capacity above 2.7 V_{Li} while ≈50% (≈1000 mAh/g_{carbon}) of the charge capacity below 3.5 V_{Li}, rendering a round-trip efficiency of ≈77%. The increased discharge capacity with decreasing current densities could be attributed to different natures of product formation/distribution affected by discharging rate. In addition to the discharge capacity, the ORR and OER activities are improved with decreasing current densities, which is in part due to the fact that lower rates give lower overpotentials.

### Methanol Oxidation Reaction

As alluded to above, the formation of multi-metal surfaces on nanoparticles can surprisingly result in enhanced catalytic activity relative to the use of nanoparticles of a similar geometry but being purely one of the multi-metal species. Accordingly, nanoparticles can be “tuned” in surface composition to provide enhanced and/or optimized catalytic activity for a given chemical reaction. Examples of such reactions include the CO oxidation reaction, the MOR, and the oxygen reduction reaction.

In one instance, the activity of the MOR utilizing nanoparticles having an overall composition of Au_{0.5}Pt_{0.5} but varying surface concentrations of Pt (10%, 30%, 65%, and 90%) are compared. The nanoparticles are synthesized and disposed on a porous carbon substrate of Vulcan XC-72 carbon. As shown in FIG. 5, a comparison of the MOR activity of Au_{0.5}Pt_{0.5}/C NPs at the different Pt surface compositions at 0.55 V vs. RHE in 0.1M HClO₄ shows that 65% Pt Au_{0.5}Pt_{0.5}/C NPs has the highest specific activity normalized to Pt surface area—about 2× higher activity than commercial Pt/C NP reference. In going from a pure Pt/C NP reference, to Pt-rich Au_{0.5}Pt_{0.5}/C NPs the activity increases and maximize at 65% Pt. As the surface composition deviates from ˜60% Pt, the activity trails off to lower activity at 30% Au, then to nearly non-existent as the concentration reaches ˜10% Au. Accordingly, the tuning of the surface concentration of Pt in AuPt nanoparticles can have a substantial effect on MOR activity.

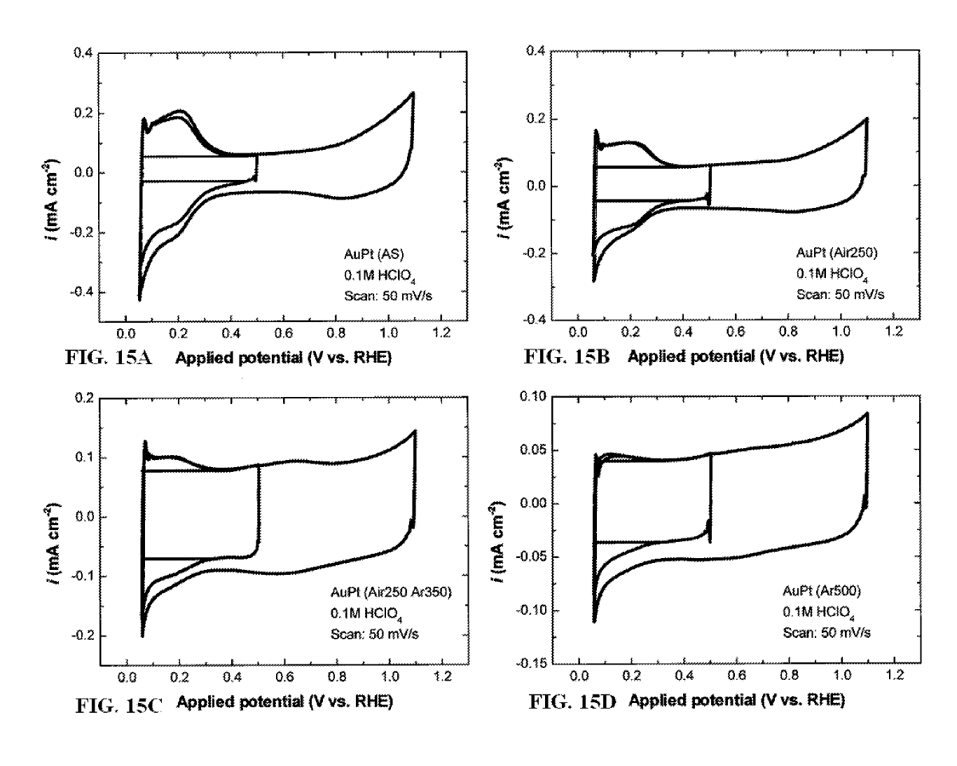

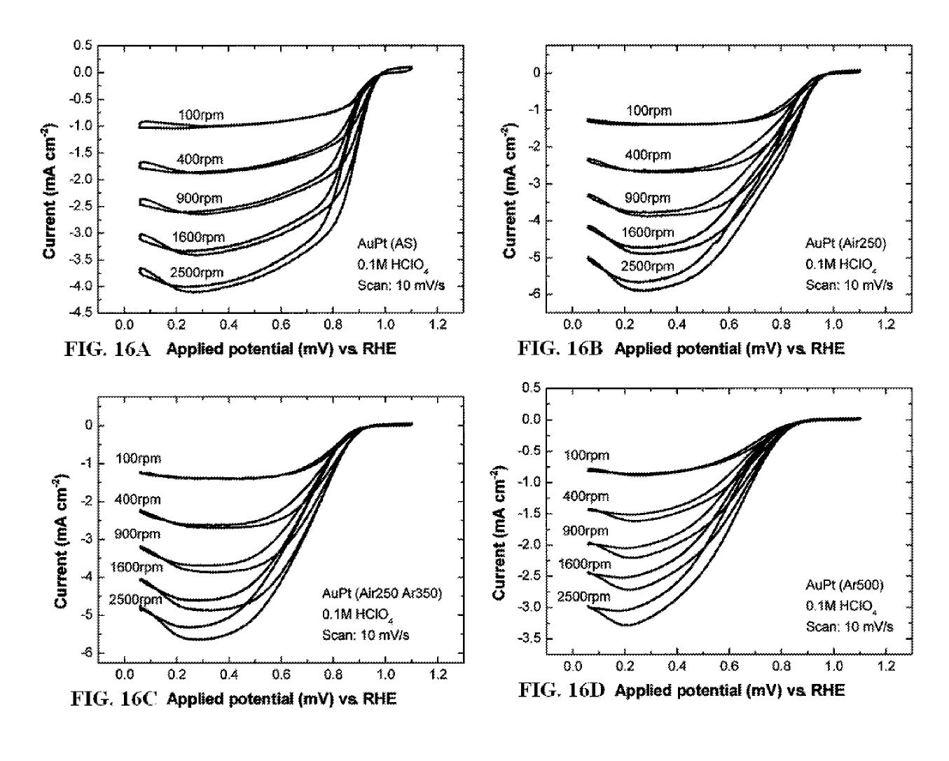

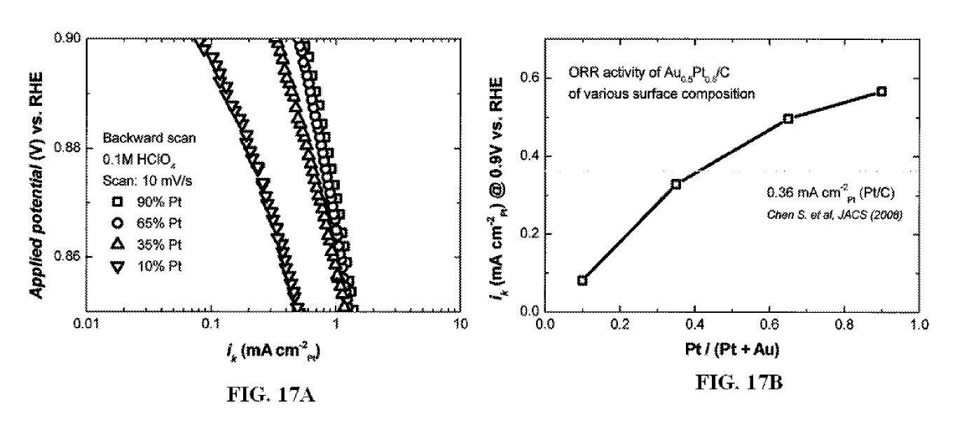

In another instance, the activity of the oxygen reduction reaction is compared utilizing nanoparticles having an overall composition of Au_{0.5}Pt_{0.5} but varying surface concentrations of Pt (10%, 30%, 65%, and 90%). As utilized in FIGS. 15 and 16, AuPt(AS) corresponds to a Pt surface concentration of 90%; AuPt(Air250) corresponds to a Pt surface concentration of 65%; AuPt(Air250 Ar350) corresponds to a Pt surface concentration of about 32%; and AuPt(Ar500) corresponds to a Pt surface concentration of 10%. FIGS. 15A-15D provide graphs showing the results of cyclic voltammetry performed using the various nanoparticles loaded onto porous carbon substrates and utilized to catalyze the oxygen reduction reaction in which the electrodes were cycled in 0.1M HClO₄ between a voltage of 0.05 and about 1.1 V relative to a reversible hydrogen electrode (RHE). The differences in the plots are characteristic of the effect of the surface concentration of Pt on the rate of oxygen reduction. FIGS. 16A-16D provide graphs showing cyclic volammetry of the nanoparticles with varying surface compositions on a rotating disk electrode operated at different rotational rates. FIGS. 17A and 17B provide graphs of measurements of the activity of the oxygen reduction reaction in terms of current as a function of applied potential relative to the RHE. Focusing on the data of applied potential at 0.9 volts shown in FIG. 17B, it is shown that the activity monotonically increases with platinum concentration at the nanoparticle surface. As well, it is shown that the presence of Au and Pt at the nanoparticle surface can result in enhanced activity relative to pure platinum at platinum concentrations above about 0.4. Accordingly, the tuning of the Pt surface concentration of AuPt nanoparticles can substantially enhance oxygen reduction reaction activity.

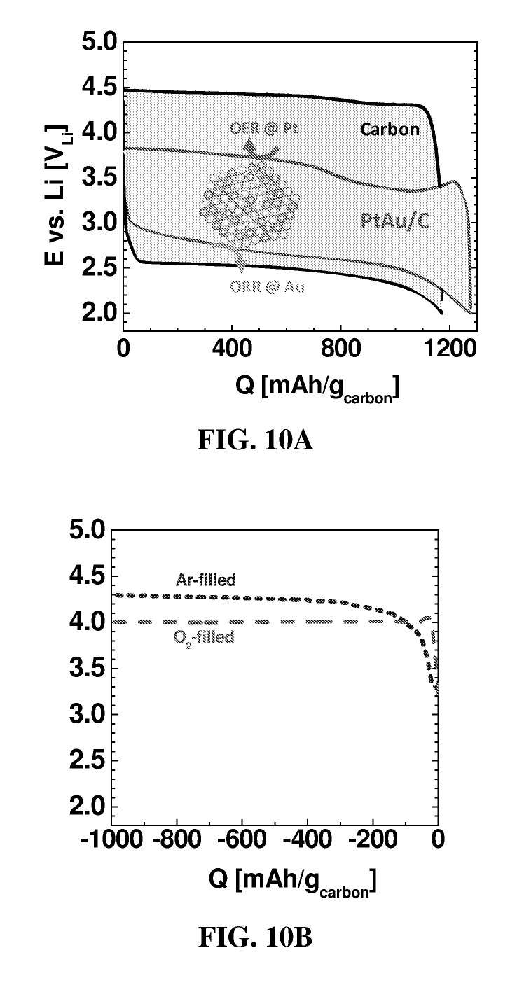

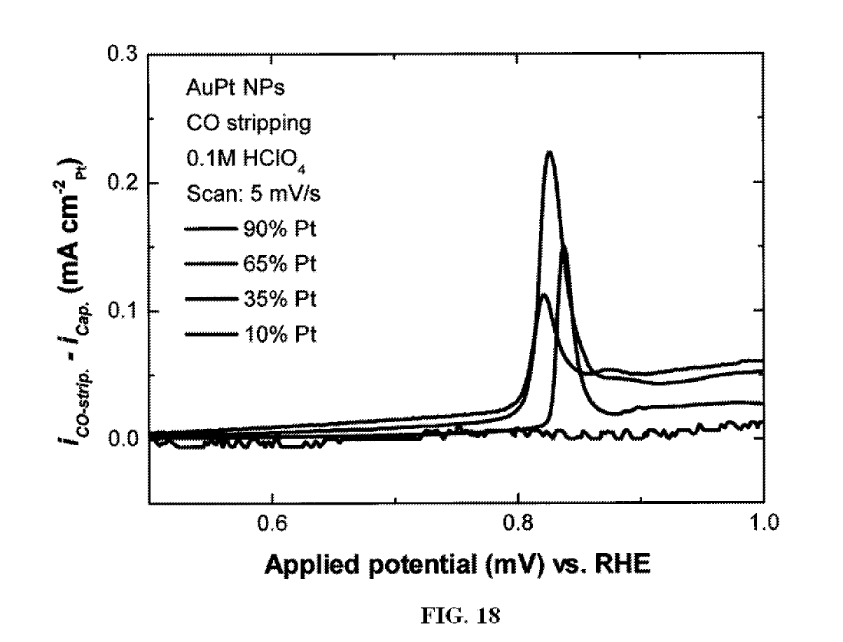

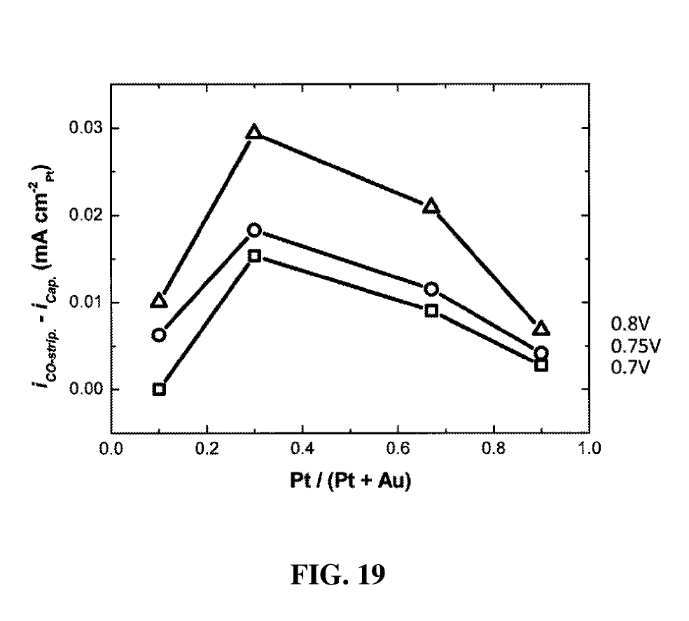

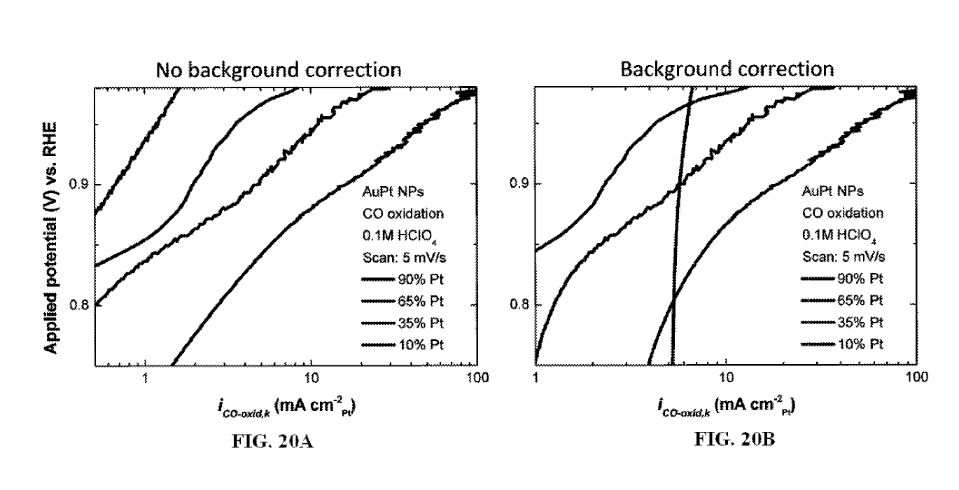

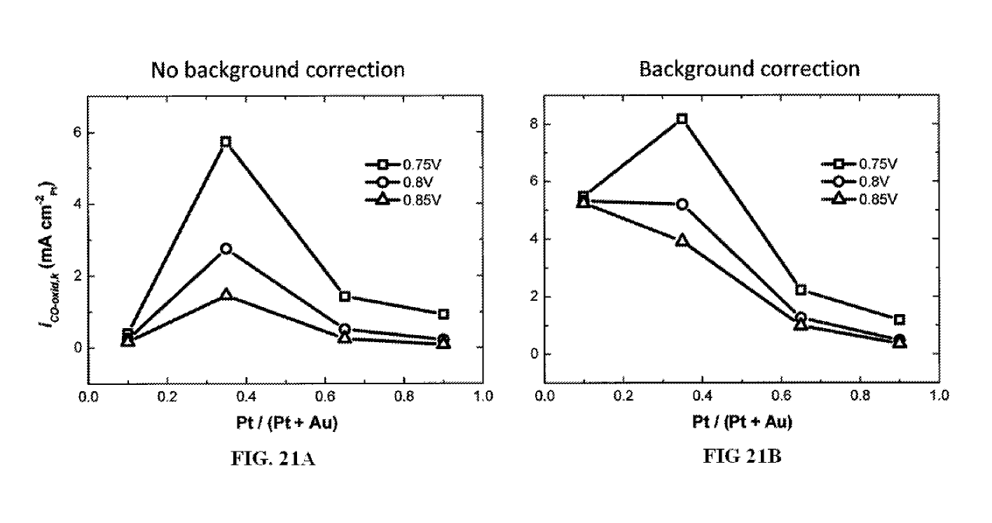

In other instances, the activity of CO oxidation is compared using the catalysts bearing the various surface Pt fractions of AuPt nanoparticles discussed above. Measurements of the relative current at which CO is stripped as a function of applied voltage relative to RHE are shown in FIG. 18 with background correction and normalized to ESA. The lowest applied voltage to induce the onset of CO stripping is for AuPt nanoparticles having a surface Pt concentration of about 35%. The data of FIG. 18 is presented in the graph of FIG. 19 as relative current of CO stripping as a function of Pt surface fraction for various applied voltages. The graph of FIG. 10 more documents that nanoparticles exhibiting a Pt surface concentration of about 35% show the highest activity. With specific regard to CO oxidation, graphs of applied voltage (vs. RHE) as a function of current from CO oxidation are presented in FIG. 20A (without background correction) and FIG. 20B (with background correction) with respect to the use of the various surface fractions of Pt on AuPt nanoparticles. FIGS. 21A (no background correction) and 21B (background correction) represent subsets of the data as plots of current from the CO oxidation reaction as a function of fraction of Pt on the surface of the AuPt nanoparticles for various iso-applied voltages vs. RHE. In general, the plots generally indicate that CO oxidation reaction activity is greatest for the AuPt nanoparticles having a Pt fraction of about 0.35. Thus, these results further demonstrate the utility of being able to tune the metal surface concentration of nanoparticles acting to catalyze an electrochemical reaction.

While the present invention has been described in terms of specific methods, structures, and devices it is understood that variations and modifications will occur to those skilled in the art upon consideration of the present invention. As well, the features illustrated or described in connection with one embodiment may be combined with the features of other embodiments. Such modifications and variations are intended to be included within the scope of the present invention. Those skilled in the art will appreciate, or be able to ascertain using no more than routine experimentation, further features and advantages of the invention based on the above-described embodiments. Accordingly, the invention is not to be limited by what has been particularly shown and described, except as indicated by the appended claims. All publications and references are herein expressly incorporated by reference in their entirety.

What is claimed is:

1. In a metal-air electrochemical cell, the improvement comprising:
a positive electrode having a catalyst comprising a plurality of nanoparticles such that the cell can be charged with a charge voltage of less than about 3.9 V_{Li}.

2. The electrochemical cell of claim 1, wherein the electrochemical cell is configured to catalyze reduction of metal oxides or oxygen during cell discharge.

3. The electrochemical cell of claim 1, wherein the electrochemical cell is configured to oxidize at least one metal-oxide species during cell charging.

4. The electrochemical cell of claim 1, wherein the catalyst comprises a first metal.

5. The electrochemical cell of claim 4, wherein the first metal is selected from the group of carbon, ruthenium, platinum, palladium, gold, manganese, iron, cobalt, nickel, copper, ruthenium, rhodium, silver, osmium, iridium, and alloys thereof.

6. The electrochemical cell of claim 4, wherein the first metal is selected from the group of platinum, palladium, and ruthenium.

7. The electrochemical cell of claim 4, wherein the catalyst further comprises a second metal selected from the group of carbon, ruthenium, platinum, palladium, gold, manganese, iron, cobalt, nickel, copper, ruthenium, rhodium, silver, osmium, iridium, and alloys thereof.

8. The electrochemical cell of claim 7, wherein an atomic ratio of the first metal and the second metal is in a range from about 100:1 to about 1:100.

9. The electrochemical cell of claim 1, wherein the positive electrode has a discharge voltage of greater than about 2.7 V_{Li} at or great than 100 mA/g_{catalyst}.

10. The electrochemical cell of claim 1, wherein the positive electrode has a discharge voltage of greater than about 2.7 V_{Li} at or great than 0.1 μA/cm²_{catalyst}.

11. The electrochemical cell of claim 1, wherein the cell can be charged with a charge voltage of less than about 3.9 V_{Li} at a capacity higher than about 200 mAh/g_{catalyst}.

12. In a metal-air electrochemical cell, the improvement comprising:
a positive electrode having a catalyst comprising a plurality of nanoparticles with a discharge voltage of greater than about 2.7 V_{Li} at or great than 100 mA/g_{catalyst}.

13. The electrochemical cell of claim 12, wherein the positive electrode has a charge voltage of less about 3.9 V_{Li}.

14. The electrochemical cell of claim 12, wherein the positive electrode has a charge voltage of less about 3.9 V_{Li} at a capacity higher than about 200 mAh/g_{catalyst}.

15. The electrochemical cell of claim 12, wherein the electrochemical cell is configured to catalyze reduction of metal oxides or oxygen during cell discharge.

16. The electrochemical cell of claim 12, wherein the electrochemical cell is configured to oxidize at least one metal-oxide species during cell charging.

17. The electrochemical cell of claim 12, wherein the catalyst comprises a first metal.

18. The electrochemical cell of claim 17, wherein the first metal is selected from the group of carbon, ruthenium, platinum, palladium, gold, manganese, iron, cobalt, nickel, copper, ruthenium, rhodium, silver, osmium, iridium, and alloys thereof.

19. The electrochemical cell of claim 17, wherein the first metal is selected from the group of platinum, palladium, and ruthenium.

20. The electrochemical cell of claim 17, wherein the catalyst further comprises a second metal selected from the group of carbon, ruthenium, platinum, palladium, gold, manganese, iron, cobalt, nickel, copper, ruthenium, rhodium, silver, osmium, iridium, and alloys thereof.

21. The electrochemical cell of claim 20, wherein an atomic ratio of the first metal and the second metal is in a range from about 100:1 to about 1:100.

22. In a metal-air electrochemical cell, the improvement comprising:
a positive electrode having a catalyst comprising a plurality of nanoparticles with a discharge voltage of greater than about 2.7 V_{Li} at or great than 0.1 μA/cm²_{catalyst}.

23. The electrochemical cell of claim 22, wherein the positive electrode has a charge voltage of less about 3.9 V_{Li}.

24. The electrochemical cell of claim 22, wherein the positive electrode has a charge voltage of less about 3.9 V_{Li} at a capacity higher than about 200 mAh/g_{catalyst}.

25. The electrochemical cell of claim 22, wherein the electrochemical cell is configured to catalyze reduction of metal oxides or oxygen during cell discharge.

26. The electrochemical cell of claim 22, wherein the electrochemical cell is configured to oxidize at least one metal-oxide species during cell charging.

27. The electrochemical cell of claim 22, wherein the catalyst comprises a first metal.

28. The electrochemical cell of claim 27, wherein the first metal is selected from the group of carbon, ruthenium, platinum, palladium, gold, manganese, iron, cobalt, nickel, copper, ruthenium, rhodium, silver, osmium, iridium, and alloys thereof.

29. The electrochemical cell of claim 27, wherein the catalyst further comprises a second metal selected from the group of carbon, ruthenium, platinum, palladium, gold, manganese, iron, cobalt, nickel, copper, ruthenium, rhodium, silver, osmium, iridium, and alloys thereof.

30. The electrochemical cell of claim 29, wherein an atomic ratio of the first metal and the second metal is in a range from about 100:1 to about 1:100.

31. In a metal-air electrochemical cell, the improvement comprising:
a positive electrode incorporating a catalyst comprising a plurality of bimetallic nanoparticles.

32. The electrochemical cell of claim 31, wherein the bimetallic nanoparticles comprise first and second metals selected from the group of carbon, ruthenium, platinum, palladium, gold, manganese, iron, cobalt, nickel, copper, ruthenium, rhodium, silver, osmium, iridium, and alloys thereof.

33. The electrochemical cell claim 32, wherein the first and second metals comprise a core-shell structure.

34. The electrochemical cell of claim 31, wherein the positive electrode has a charge voltage of less about 3.9 V_{Li}.

35. The electrochemical cell of claim 31, wherein the positive electrode has a charge voltage of less about 3.9 V_{Li} at a capacity higher than about 200 mAh/g_{catalyst}.

36. The electrochemical cell of claim 31, wherein the positive electrode has a discharge voltage of greater than about 2.7 V_{Li} at or great than 100 mA/g_{catalyst}.

37. The electrochemical cell of claim 31, wherein the positive electrode has a discharge voltage of greater than about 2.7 V_{Li} at or great than 0.1 μA/cm²_{catalyst}.

38. The electrochemical cell of claim 33, wherein the shell comprises an average thickness of about one to about fifty atomic monolayers of the first metal.

39. The electrochemical cell of claim 33, wherein the core comprises a metal oxide and the shell comprises a bimetallic material comprising platinum.

40. The electrochemical cell of claim 33, wherein the core comprises a metal oxide and the shell comprises a bimetallic material comprising palladium.

41. The electrochemical cell of claim 33, wherein the core comprises a metal oxide and the shell comprises a bimetallic material comprising ruthenium.

42. A method of catalyzing an electrochemical reaction in a metal-air electrochemical cell, the method comprising
providing a source of metal at a negative electrode;
providing a catalyst at a positive electrode; and
catalyzing oxidation of at least one metal-oxide species during the application of a charging voltage of less than about 3.9 V_{Li}.

43. The electrochemical cell of claim 42, catalyzing oxidation of at least one metal-oxide species during the application of a charging voltage of less than about 3.9 V_{Li} at a capacity higher than about 200 mAh/g_{catalyst}.

44. The method of claim 42, wherein the catalyst comprises a first metal selected from the group of carbon, ruthenium, platinum, palladium, gold, manganese, iron, cobalt, nickel, copper, ruthenium, rhodium, silver, osmium, iridium, and alloys thereof.

45. The method of claim 44, wherein the catalyst further comprises a second metal selected from the group of carbon, ruthenium, platinum, palladium, gold, manganese, iron, cobalt, nickel, copper, ruthenium, rhodium, silver, osmium, iridium, and alloys thereof.

46. A method of catalyzing an electrochemical reaction in a metal-air electrochemical cell, the method comprising
providing a source of metal at a negative electrode;
providing a catalyst at a positive electrode; and
catalyzing reduction of metal oxides or oxygen at the positive electrode to generate a discharge voltage of greater than about 2.7 V_{Li} at or great than 100 mA/g_{catalyst}.

47. The method of claim 46, wherein the catalyst comprises a first metal selected from the group of carbon, ruthenium, platinum, palladium, gold, manganese, iron, cobalt, nickel, copper, ruthenium, rhodium, silver, osmium, iridium, and alloys thereof.

48. The method of claim 47, wherein the catalyst further comprises a second metal selected from the group of carbon, ruthenium, platinum, palladium, gold, manganese, iron, cobalt, nickel, copper, ruthenium, rhodium, silver, osmium, iridium, and alloys thereof.

49. A method of catalyzing an electrochemical reaction in a metal-air electrochemical cell, the method comprising
providing a source of metal at a negative electrode;
providing a catalyst at a positive electrode; and
catalyzing reduction of metal oxides or oxygen at the positive electrode to generate a discharge voltage of greater than about 2.7 V_{Li} at or great than 0.1 μA/cm²_{catalyst}.

50. The method of claim 49, wherein the catalyst comprises a first metal selected from the group of carbon, ruthenium, platinum, palladium, gold, manganese, iron, cobalt, nickel, copper, ruthenium, rhodium, silver, osmium, iridium, and alloys thereof.

51. The method of claim 47, wherein the catalyst further comprises a second metal selected from the group of carbon, ruthenium, platinum, palladium, gold, manganese, iron, cobalt, nickel, copper, ruthenium, rhodium, silver, osmium, iridium, and alloys thereof.

52. In a metal-air electrochemical cell, the improvement comprising:
a positive electrode incorporating a catalyst comprising platinum-containing nanoparticles on a porous substrate.

53. The electrochemical cell of claim 52, wherein the electrochemical cell is configured to catalyze reduction of metal oxides or oxygen during cell discharge

54. The electrochemical cell of claim 52, wherein the electrochemical cell is configured to oxidize at least one metal-oxide species during cell charging.

55. The electrochemical cell of claim 52, wherein the nanoparticles are characterized by a platinum atomic fraction in a range from about 0.01% to 100%.

56. The electrochemical cell of claim 52, wherein the catalyst further comprises a second metal.

57. The electrochemical cell of claim 56, wherein the second metal comprises at least one of metal selected from the group of carbon, ruthenium, palladium, gold, manganese, iron, cobalt, nickel, copper, ruthenium, rhodium, silver, osmium, iridium, and alloys thereof.

58. The electrochemical cell claim 52, wherein the catalyst further comprises an oxide of one or more of the metals.

59. The electrochemical cell of claim 56, wherein an atomic ratio of the platinum and the second metal is in a range from about 100:1 to about 1:100.

60. The electrochemical cell of claim 56, wherein a surface composition ratio of the platinum and the second metal is in a range from about 20:1 to about 1:20.

61. In a metal-air electrochemical cell, the improvement comprising:
a positive electrode incorporating a catalyst comprising palladium-containing nanoparticles on a porous substrate.

62. The electrochemical cell of claim 61, wherein the electrochemical cell is configured to catalyze reduction of metal oxides or oxygen during cell discharge

63. The electrochemical cell of claim 61, wherein the electrochemical cell is configured to oxidize at least one metal-oxide species during cell charging.

64. The electrochemical cell of claim 61, wherein the nanoparticles are characterized by a platinum atomic fraction in a range from about 0.01% to 100%.

65. The electrochemical cell of claim 61, wherein the catalyst further comprises a second metal.

66. The electrochemical cell of claim 65, wherein the second metal comprises at least one of metal selected from the group of carbon, ruthenium, platinum, gold, manganese, iron, cobalt, nickel, copper, ruthenium, rhodium, silver, osmium, iridium, and alloys thereof.

67. The electrochemical cell claim 61, wherein the catalyst further comprises an oxide of one or more of the metals.

68. The electrochemical cell of claim 66, wherein an atomic ratio of the palladium and the second metal is in a range from about 100:1 to about 1:100.

69. The electrochemical cell of claim 66, wherein a surface composition ratio of the palladium and the second metal is in a range from about 20:1 to about 1:20.

70. In a metal-air electrochemical cell, the improvement comprising:
a positive electrode incorporating a catalyst comprising ruthenium-containing nanoparticles on a porous substrate.

71. The electrochemical cell of claim 70, wherein the electrochemical cell is configured to catalyze reduction of metal oxides or oxygen during cell discharge

72. The electrochemical cell of claim 70, wherein the electrochemical cell is configured to oxidize at least one metal-oxide species during cell charging.

73. The electrochemical cell of claim 70, wherein the nanoparticles are characterized by a platinum atomic fraction in a range from about 0.01% to 100%.

74. The electrochemical cell of claim 70, wherein the catalyst further comprises a second metal.

75. The electrochemical cell of claim 70, wherein the second metal comprises at least one of metal selected from the group of carbon, ruthenium, platinum, palladium, gold, manganese, iron, cobalt, nickel, copper, rhodium, silver, osmium, iridium, and alloys thereof.

76. The electrochemical cell claim 75, wherein the catalyst further comprises an oxide of one or more of the metals.

77. The electrochemical cell of claim 74, wherein an atomic ratio of the ruthenium and the second metal is in a range from about 100:1 to about 1:100.

78. The electrochemical cell of claim 74, wherein a surface composition ratio of the ruthenium and the second metal is in a range from about 20:1 to about 1:20.
